(19) United States
(12) Patent Application Publication
(10) Pub. No.: US 2012/0291014 A1
(43) Pub. Date: Nov. 15, 2012

(54) SYSTEM AND METHOD FOR TESTING THE DEVELOPMENT AND UPDATES IN A TEST SYSTEM USING PRODUCTION/LIVE DATA

(76) Inventor: Sridhar Shrinivasan, Aston, PA (US)

(21) Appl. No.: 13/267,062

(22) Filed: Oct. 6, 2011

Related U.S. Application Data
(60) Provisional application No. 61/484,087, filed on May 9, 2011.

(51) Int. Cl. G06F 9/44; G06F 17/30

(52) U.S. Cl. 717/124

(57) ABSTRACT

A software testing system and method is disclosed for a production system and production database. The method includes creating a test system for testing aspects of the production system; initializing a test database; processing program statements in the test system using the test database; not changing the production database when processing statements in the test system; and when the program statement in the test system acts upon a targeted database record, copying the targeted record from the production to the test database only if necessary. When the program statement is a select or update statement, the method can include checking if the test database includes the targeted record, if so processing the statement using the record in the test database; and if not copying the targeted record from the production to the test database, and processing the statement using the record in the test database.

### CROSS-REFERENCE TO RELATED APPLICATIONS

This application claims the benefit of U.S. Provisional Application Ser. No. 61/484,087, filed on May 9, 2011, entitled “System and Method for Testing the Development and Updates in a Test System Using Production/Live Data” which is incorporated herein by reference.

### BACKGROUND AND SUMMARY

The present invention relates to computer system testing, and more particularly to systems and methods for software testing.

In implementation, upgrade, repair or maintenance projects (collectively system updates) of computerized systems, there are multiple servers and/or databases that are maintained in a test environment as well as in a production or live environment. This is to ensure that the system changes are tested in the test environment before the changes are made to the production or live system. The test system may be called by various names, for example, sandbox system, development system, quality system, etc. The test system can include databases, system settings, program codes, interface settings, etc. The production system may also be called by various names, for example, live system, real time system, PROD system, etc. The production system is the system where live data is maintained, processed and updated during operations in real time.

In many cases, there are three layers of system/servers/databases:
1) Sandbox/development system where system configuration/program changes are made;
2) Quality system where the most recent data is available for final sanity testing; and
3) Production/live system where the changes are finally implemented manually or systematically.

FIG. 1 illustrates a typical scenario for software testing. A test system 10 is used for testing of a production system 20. Separate databases and/or servers are maintained for each of the test system 10 and the production system 20. Periodically data is moved from the test system 10 to the production system 20 along a data connection 12. The data from the test system 10 can include program changes and/or system setting changes that are moved systematically or manually to the production system 20. These changes are moved from the test system 10 to the production system 20 after testing/validation of the changes on the test system 10. Periodically the database is moved from the production system 20 to the test system 10 along a data connection 14 to make the testing more meaningful. The copying of production system data to the test system helps facilitate testing the configuration/program updates with meaningful data.

The typical testing scenario can have issues concerning the status of the data in the test system (sandbox/development systems) and in the production (live) system. In the test system, master data (e.g. Material, Customer, Vendor, etc.) and transaction data (e.g. Sales order, Purchase order, FI documents, Invoices, etc.) are typically static and current as of the last date the production data was copied to the test system. However, in the production system, the master and transaction data are real-time, constantly changing data. In the test system, system settings and program codes are also typically current as of the last date the production data was copied to the test system and may include updates made to the test system. However, in the production system, the system settings and program codes are typically current as of the last system change and there are generally no direct updates in the production system of system settings or program codes.

Some of the data issues that this testing scenario can present include the following. The test systems have to be updated periodically with copies of the production system data so that they have meaningful data for testing. In the case of data extensive sites (for example, companies with data intensive operations), the copying of production system data to test systems can require significant effort and resources. Even with periodic copying schemes, there can be difficulty in replicating an issue occurring in the production/live system on the test systems, as the master and/or transaction data is constantly changing in the production/live systems. Due to these issues, the testing is not always foolproof or adequate. It would be desirable to overcome some or all of these issues in system testing.

A software testing system is disclosed that includes a production system, a test system for testing proposed changes to the production system, a production database containing data for processing by the production system and a test database containing data for processing by the test system. When the test system processes a program statement that acts upon a targeted database record, the test system processes the program statement using the test database updated as needed from the production database, and the test system does not change the production database. When the program statement is a select statement, the test system can check if the test database includes the targeted database record, if the test database includes the targeted database record then the test system can process the program statement using the targeted database record in the test database, otherwise the test system can copy the targeted database record from the production database to the test database and then the test system can process the program statement using the targeted database record in the test database. When the program statement is an update statement, the test system can check if the test database includes the targeted database record, if the test database includes the targeted database record then the test system can execute the update statement on the targeted database record in the test database, otherwise the test system can copy the targeted database record from the production database to the test database and then the test system can execute the update statement on the targeted database record in the test database. When the program statement is a commit statement, the test system can update the targeted database record in the test database from internal memory. When the program statement is a lock statement, the test system can lock the targeted database record in the test database.

A software testing method is disclosed for a production system and a production database containing data for processing by the production system. The software testing method includes creating a test system for testing aspects of the production system; initializing a test database containing data for processing by the test system; processing program statements in the test system using the test database; not changing the production database when processing the program statements in the test system; and when the program statement in the test system acts upon a targeted database record, copying the targeted database record from the production database to the test database only if necessary.

When the program statement in the test system is a select statement, the software testing method can also include checking if the test database includes the targeted database record, if the test database includes the targeted database record, processing the program statement using the targeted database record in the test database; and if the test database does not include the targeted database record, copying the targeted database record from the production database to the test database, and then processing the program statement using the targeted database record in the test database. When the program statement in the test system is an update statement, the software testing method can also include checking if the test database includes the targeted database record; if the test database includes the targeted database record, executing the update statement on the targeted database record in the test database; and if the test database does not include the targeted database record, copying the targeted database record from the production database to the test database, and then executing the update statement on the targeted database record in the test database. When the update statement is for less than all the fields in the targeted database record, copying the targeted database record can include copying the full targeted database record from the production database to the test database. When the program statement is a commit statement, the software testing method can also include updating the targeted database record in the test database from internal memory. When the program statement is a lock statement, the software testing method can also include locking the targeted database record in the test database.

When the program statement in the test system is an update statement, the software testing method can also include checking an identifier indicating whether in test mode or live mode; and when the identifier indicates test mode the method can include not changing the production database; checking if the test database includes the targeted database record; if the test database includes the targeted database record, executing the update statement on the targeted database record in the test database; and if the test database does not include the targeted database record, copying the targeted database record from the production database to the test database, and then executing the update statement on the targeted database record in the test database. When the program statement in the test system is a select statement, the software testing method can also include checking if the test database includes the targeted database record, if the test database includes the targeted database record, checking if the targeted database record is the same in the test database and the production database; if the targeted database record is the same in the test database and the production database, processing the program statement using the targeted database record in the test database; if the targeted database record is not the same in the test database and the production database, copying the targeted database record from the production database to the test database, and then processing the program statement using the targeted database record in the test database; and if the test database does not include the targeted database record, copying the targeted database record from the production database to the test database, and then processing the program statement using the targeted database record in the test database. When the program statement in the test system is an update statement, the software testing method can also include checking if the test database includes the targeted database record, if the test database includes the targeted database record, checking if the targeted database record is the same in the test database and the production database; if the targeted database record is the same in the test database and the production database, executing the update statement on the targeted database record in the test database; if the targeted database record is not the same in the test database and the production database, copying the targeted database record from the production database to the test database, and then executing the update statement on the targeted database record in the test database; and if the test database does not include the targeted database record, copying the targeted database record from the production database to the test database, and then executing the update statement on the targeted database record in the test database.

### BRIEF DESCRIPTION OF THE DRAWINGS

FIG. 1 illustrates a typical scenario for software testing;

FIG. 2 illustrates an exemplary embodiment for an improved software testing system;

FIG. 3 shows a flow diagram for an exemplary processing method of a select statement in the testing system; and

FIG. 4 shows a flow diagram for an exemplary processing method of an update statement in the testing system.

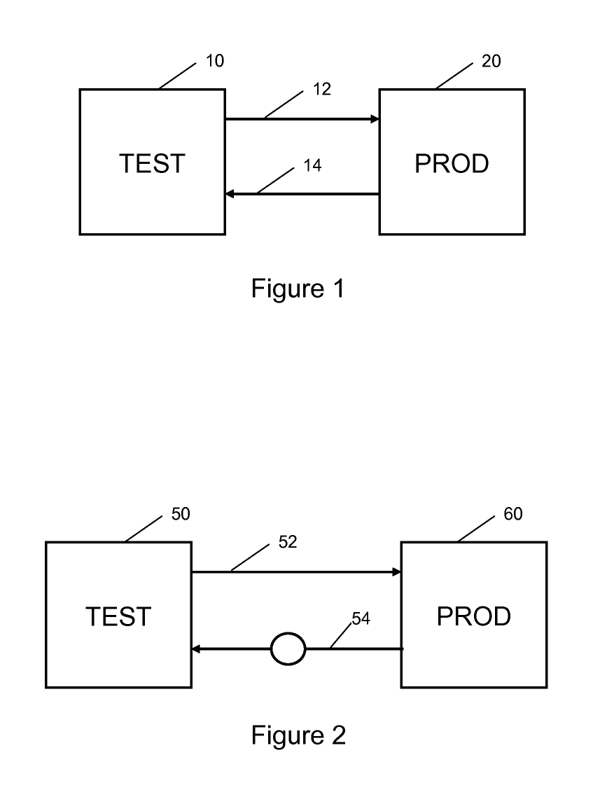

### DESCRIPTION OF EXEMPLARY EMBODIMENTS

The exemplary embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

FIG. 2 illustrates an exemplary embodiment for improved software testing. A test system 50 is used for testing of a production system 60. Separate databases and/or servers are maintained for each of the test system 50 and the production system 60. Periodically data is moved from the test system 50 to the production system 60 along a data connection 52. As in the previous scenario, the data from the test system 50 can include program changes and/or system setting changes that are moved systematically or manually to the production system 60 after testing/validation of the changes on the test system 50. In contrast to the previous scenario, data is moved from the production system 60 to the test system 50 along a data connection 54 on an as needed basis to make the testing more meaningful. During testing, only targeted records from the production system 60 are copied to the test system 50.

In a test system, the system settings/configuration and program code is maintained and updated as required by the user or update/maintenance processes. On the test database side, an empty database structure can be maintained at the start of testing. When a test is performed, the test program executes normally except in the following cases: any program statement that selects, updates, commits or performs any activity with the database tables/records can be dealt with as described below from the database software perspective.

Some examples of statements that the test system will deal with differently are the following. A select statement which is a program statement to select record(s) from a table where the selected records satisfy a certain criteria. An update statement which is a program statement to update (add or modify) record(s) in a table. A commit statement which is a program statement to update record(s) in the database from internal memory. A lock statement which is a program statement to lock record(s) from being modified by other users. Any statement that reads from the database can be handled as described for a select statement. Any statement that updates or writes to the database can be handled as described for an update statement.

The system database can include system settings tables, master data tables and transaction data tables. System settings tables may be controlled to select from the test system. In many systems, structured query language (SQL) trace is available to review the table/records selected. This can help analyze how the system performed the test.

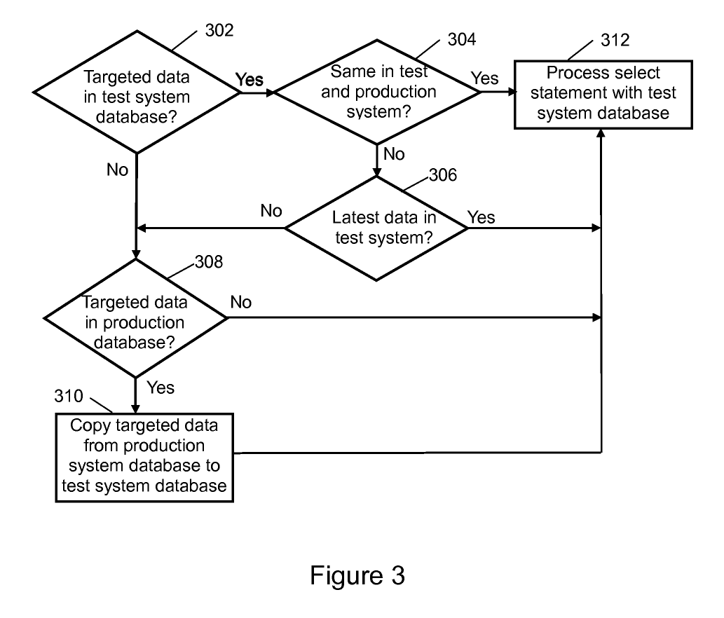

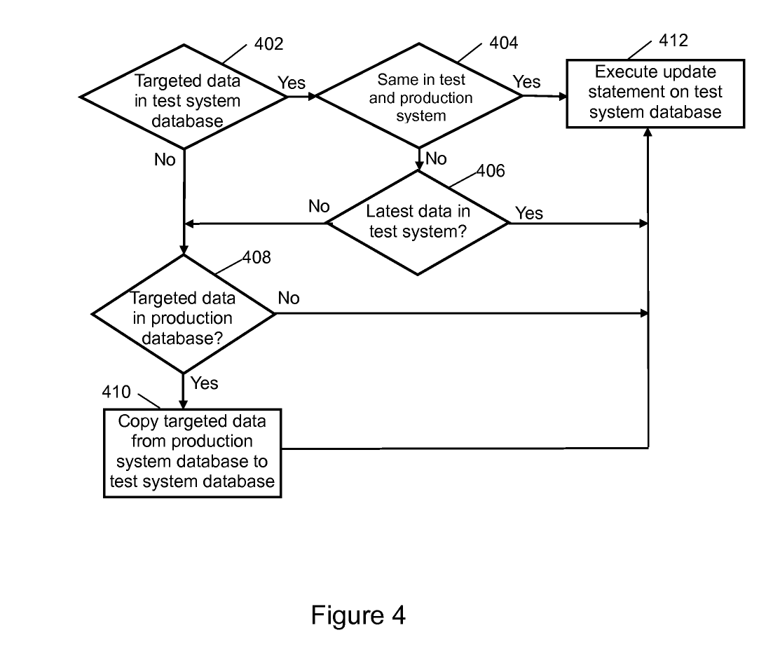

When a test is initiated the system records the start time and date for the test and a user identifier (user id) for the user that initiated the test. FIGS. 3 and 4 show exemplary methods for handling select and update statements in the test system.

FIG. 3 shows a flow diagram for an exemplary processing method of a select statement for master or transaction data tables in the testing system. A select statement does not require a write to the database in normal processing. At block 302, the test system checks if the targeted data for the select statement is already in the test database. If the current test system database already contains the targeted database tables/records of the select statement, then control passes to block 304. If the current test system database does not contain the targeted database tables/records of the select statement, then control passes to block 308.

At block 304, the system compares the targeted data records in the test system to the targeted data records in the production system to determine if the records are the same. If the records are not the same, then control passes to block 306. If the records are the same in the test and production systems, then control passes to block 312.

At block 306, the test system checks if the latest data for testing is in the test system database. This check can be done by comparing a date/time and user id for the test data record to the date/time and user id for the test start. If the user ids for the test and the test data record match, and the date/time associated with the test data record is after the date/time for the start of the test, then the test data record has already been updated from the production database and the data record in the test database should be used. If the user ids do not match, or the date/time associated with the test data record is before the date/time for the start of the test, then the test data record has not already been updated and the data record from the production database should be used. If the latest data is in the test system database then control passes to block 312, otherwise control passes to block 308.

At block 308, the test system checks if the targeted database tables/records of the select statement are in the production/live system. If the targeted database records of the select statement are in the production/live system then control passes to block 310, otherwise control passes to block 312. The test system can include code to handle when the targeted database tables/records are not in the test or the production/live systems.

At block 310, the test system updates the current test system database by copying the targeted database tables/records of the select statement from the designated production/live system to the test system database. The date/time of the copying to the test database and the user id of the user performing the test are also stored and associated with the copied test data record. Then control passes to block 312.

At block 312, the test system processes the select statement with the data record in the test system database. The system can also store or update the date/time associated with the selected test data record with the date/time of the select statement execution.

FIG. 4 shows a flow diagram for an exemplary processing method of an update statement in the testing system. An update statement includes a write to the database. At block 402, the test system checks if the targeted data for the update statement is already in the test database. If the current test system database already contains the targeted database tables/records of the update statement, then control passes to block 404. If the current test system database does not contain the targeted database tables/records of the update statement, then control passes to block 408.

At block 404, the system compares the targeted data records in the test system to the targeted data records in the production system to determine if the records are the same. If the records are not the same, then control passes to block 406. If the records are the same in the test and production systems, then control passes to block 412.

At block 406, the test system checks if the latest data for testing is in the test system database. As explained above with reference to block 306, this check can be done by comparing a date/time and user id for the test data record to the date/time and user id for the test start. If the latest data is in the test system database then control passes to block 412, otherwise control passes to block 408.

At block 408, the test system checks if the targeted database tables/records of the update statement are in the production/live system. If the targeted database records of the update statement are in the production/live system then control passes to block 410, otherwise control passes to block 412. The test system can include code to handle when the targeted database tables/records are not in the test or the production/live systems.

At block 410, the test system updates the current test system database by copying the targeted database tables/records of the update statement from the designated production/live system to the test system database. The date/time of the copying to the test database and the user id of the user performing the test are also stored and associated with the copied test data record. Then control passes to block 412.

At block 412, the test system executes the update statement with the data record in the test system database. The system can also store or update the date/time associated with the test data record with the date/time of the update statement execution.

When an update statement is executed by the test system, the test system updates only the test system database. This can be controlled by a user identifier and/or server identifier (where executed) as an additional safeguard. If the update is for a single field of a targeted record, the full record is copied from the production system database and updated in the test system database. Sufficient control is necessary to avoid updating of the production/live system database by the test system.

An exemplary processing method of a commit statement in the testing system is to commit only in the test system, i.e. update only the test system database from internal memory.

An exemplary processing method of a lock statement in the testing system is to lock only in the test system, i.e. only lock records in the test system database from being modified by other users.

To update the test system database, number ranges may be required to find the next available number to be assigned to a document. If the select statement is designed as outlined above, it can pick up the next available number as it would occur in the production/live system.

These and other statements that access or update database tables/records can be modified in the system. The modifications can include changing the tag in the syntax of the statement to indicate whether the statement is in the test system environment or the production system environment. Code will be the same for all systems. Depending on where executed, the tags in the syntax will determine the way the statement is handled. For example, a select or update statement in the test system can include a tag system id=“test”. When this statement is executed in test, then the system will follow processes outlined herein as opposed to executing the same statement as in the live system.

Alternatively, the above testing system can be implemented by changing the existing program code instead of changing the way that the select/update statements work (more like database software behavioral change). For example, the program code can include a branch statement before a select or update statement. An example of such a branch statement is:

```
If system id = “test”
      Statement(s) for execution in test scenario
Else
      Statement(s) for execution in production scenario
Endif
```

The disclosed test system and method can include several advantages. Using this system, there is no need to copy all of the database/tables from the production system to the test system which provides a savings of hardware, software, and programmer cost. There is also no need to prepare the test data which provides large savings of time and effort. The testing is quick, effective and foolproof because the live data is used by the test system to simulate the effect of the system/program changes.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains.

We claim:

1. A software testing system comprising:
a production system;
a test system for testing proposed changes to the production system;
a production database containing data for processing by the production system;
a test database containing data for processing by the test system;
wherein when the test system processes a program statement that acts upon a targeted database record, the test system processes the program statement using the test database updated as needed from the production database, and the test system does not change the production database.

2. The software testing system of claim 1, wherein when the program statement is a select statement, the test system checks if the test database includes the targeted database record, if the test database includes the targeted database record then the test system processes the program statement using the targeted database record in the test database, otherwise the test system copies the targeted database record from the production database to the test database and then the test system processes the program statement using the targeted database record in the test database.

3. The software testing system of claim 2, wherein when the program statement is an update statement, the test system checks if the test database includes the targeted database record, if the test database includes the targeted database record then the test system executes the update statement on the targeted database record in the test database, otherwise the test system copies the targeted database record from the production database to the test database and then the test system executes the update statement on the targeted database record in the test database.

4. The software testing system of claim 3, wherein when the program statement is a commit statement, the test system updates the targeted database record in the test database from internal memory.

5. The software testing system of claim 4, wherein when the program statement is a lock statement, the test system locks the targeted database record in the test database.

6. The software testing system of claim 1, wherein when the program statement is an update statement, the test system checks if the test database includes the targeted database record, if the test database includes the targeted database record then the test system executes the update statement on the targeted database record in the test database, otherwise the test system copies the targeted database record from the production database to the test database and then the test system executes the update statement on the targeted database record in the test database.

7. The software testing system of claim 1, wherein when the program statement is a commit statement, the test system updates the targeted database record in the test database from internal memory.

8. The software testing system of claim 1, wherein when the program statement is a lock statement, the test system locks the targeted database record in the test database.

9. A software testing method for a production system and a production database containing data for processing by the production system, the software testing method comprising:
creating a test system for testing aspects of the production system;
initializing a test database containing data for processing by the test system;
processing program statements in the test system using the test database;
not changing the production database when processing the program statements in the test system; and
when the program statement in the test system acts upon a targeted database record, copying the targeted database record from the production database to the test database only if necessary.

10. The software testing method of claim 9, wherein when the program statement in the test system is a select statement, the software testing method further comprises:
checking if the test database includes the targeted database record,
if the test database includes the targeted database record, processing the program statement using the targeted database record in the test database;
if the test database does not include the targeted database record, copying the targeted database record from the production database to the test database, and then processing the program statement using the targeted database record in the test database.

11. The software testing method of claim 10, wherein when the program statement in the test system is an update statement, the software testing method further comprises:
checking if the test database includes the targeted database record;
if the test database includes the targeted database record, executing the update statement on the targeted database record in the test database;
if the test database does not include the targeted database record, copying the targeted database record from the production database to the test database, and then executing the update statement on the targeted database record in the test database.

12. The software testing method of claim 11, wherein when the update statement is for less than all the fields in the targeted database record, copying the targeted database record comprises:
copying the full targeted database record from the production database to the test database.

13. The software testing method of claim 11, further comprising:
when the program statement is a commit statement, updating the targeted database record in the test database from internal memory.

14. The software testing method of claim 12, further comprising:
when the program statement is a lock statement, locking the targeted database record in the test database.

15. The software testing method of claim 9, wherein when the program statement in the test system is an update statement, the software testing method further comprises:
checking an identifier indicating whether in test mode or live mode;
when the identifier indicates test mode,
not changing the production database;
checking if the test database includes the targeted database record;
if the test database includes the targeted database record, executing the update statement on the targeted database record in the test database;
if the test database does not include the targeted database record, copying the targeted database record from the production database to the test database, and then executing the update statement on the targeted database record in the test database.

16. The software testing method of claim 9, wherein when the program statement in the test system is a select statement, the software testing method further comprises:
checking if the test database includes the targeted database record,
if the test database includes the targeted database record, checking if the targeted database record is the same in the test database and the production database;
if the targeted database record is the same in the test database and the production database, processing the program statement using the targeted database record in the test database;
if the targeted database record is not the same in the test database and the production database, copying the targeted database record from the production database to the test database, and then processing the program statement using the targeted database record in the test database; and
if the test database does not include the targeted database record, copying the targeted database record from the production database to the test database, and then processing the program statement using the targeted database record in the test database.

17. The software testing method of claim 9, wherein when the program statement in the test system is an update statement, the software testing method further comprises:
checking if the test database includes the targeted database record,
if the test database includes the targeted database record, checking if the targeted database record is the same in the test database and the production database;
if the targeted database record is the same in the test database and the production database, executing the update statement on the targeted database record in the test database;
if the targeted database record is not the same in the test database and the production database, copying the targeted database record from the production database to the test database, and then executing the update statement on the targeted database record in the test database; and
if the test database does not include the targeted database record, copying the targeted database record from the production database to the test database, and then executing the update statement on the targeted database record in the test database.

18. The software testing method of claim 9, further comprising:
when the program statement is a commit statement, updating the targeted database record in the test database from internal memory.

19. The software testing method of claim 9, further comprising:
when the program statement is a lock statement, locking the targeted database record in the test database.
